(19) United States
(12) Patent Application Publication
(10) Pub. No.: US 2003/0049526 A1
(43) Pub. Date: Mar. 13, 2003

(54) Power generating device for an electrical appliance that consumes little electricity

(76) Inventor: Sueng-Nien Kao, Hsin Tien City (TW)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 09/949,386

(22) Filed: Sep. 7, 2001

(51) Int. Cl. H01M 2/02; H01M 2/14; H01M 4/38; H01M 4/40

(52) U.S. Cl. 429/176; 429/231.95; 429/220; 429/223; 429/224; 429/129

(57) ABSTRACT

A power generating device for an electrical appliance which consumes little electricity has a cathode, an anode and a container. The cathode is adapted to be securely attached to the electrical appliance. The anode is adapted to be securely attached to the electrical appliance and the cathode through the circuitry of the appliance. The container has water in the container to immerse the cathode and anode in the water so that a chemical reaction between the cathode and anode generates electricity for the electrical appliance.

### BACKGROUND OF THE INVENTION

1. Field of the Invention

The present invention relates to a power generating device, and more particularly to a power generating device for an electrical appliance that consumes little electricity. The power generating device has a cathode made of an alloy of aluminum and magnesium, an anode of cupronickel and water surrounding the cathode and anode. With such an arrangement, less electrolyte is generated so the chemical reaction between the cathode and the anode will be prolonged for a longer period of time, and the generated voltage also increases so as to meet the need of the electrical appliance.

2. Description of Related Art

A power generating device for an electrical appliance that consumes little electricity has been in the market for a long time. The power generating device has a cathode of zinc, an anode of copper and salt water in a container. Using the salt water as a catalyst, the chemical reaction between the cathode and anode is able to continue for quite a long period of time. However, during the chemical reaction of the cathode and anode, electrolyte residue is generated. The electrolyte is a white, powder-like substance and clouds the salt water. Further, the chemical reaction between the cathode and anode breaks down the salt water in the container. Consequently, fresh salt water must be added from time to time to maintain the normal operation of the power generating device, which requires the power generating device be close to the source of salty water. Moreover, the addition of salty water increases the reaction between the cathode and anode, which increases the deterioration of the cathode.

To overcome the shortcomings, the present invention tends to provide an improved power generating device to mitigate and obviate the aforementioned problems.

### SUMMARY OF THE INVENTION

The primary objective of the invention is to provide a power generating device having water in a container, a cathode of an alloy of aluminum and magnesium and an anode of cupronickel. The cathode and anode are immersed in the water to allow a reaction between the two. Because the chemical reaction between the cathode and anode takes place in fresh water, the need for salt water is obviated.

Another objective of the invention is to maintain the chemical reaction between the cathode and anode even when the cathode and anode are not in the container. This is accomplished by mounting a saturated sponge between the cathode and anode.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the power generating device in accordance with the present invention;

FIG. 2 is a side plan view in partial section of a preferred embodiment of the assembled power generating device; and

FIG. 3 is a side plan view in partial section of the embodiment shown in FIG. 2 without the sponge.

### DETAILED DESCRIPTION OF THE PREFERRED EMBODIMENT

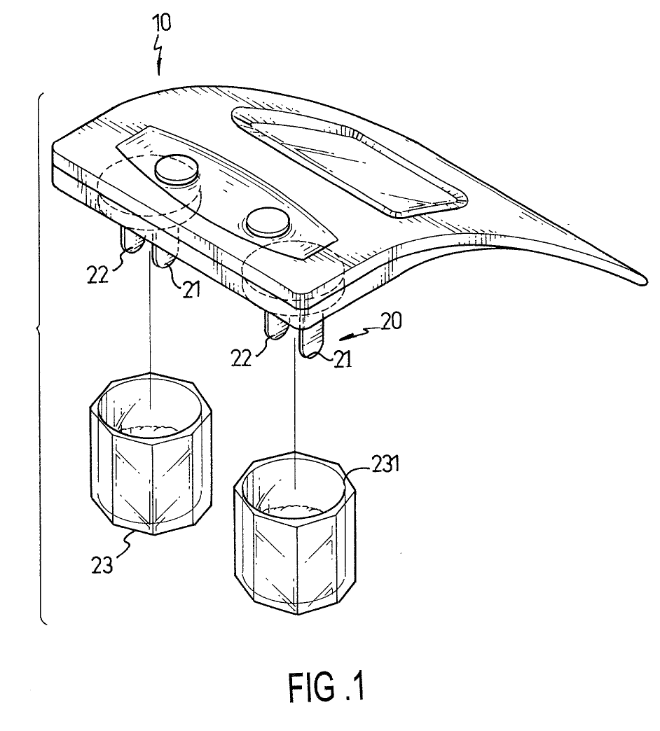

With reference to FIG. 1, the power generating device in accordance with the present invention used with an electrical appliance (10), such as a calculator, a clock, etc., includes at least one set of a power-generating elements (20) (two sets of power-generating elements are provided in this embodiment). A set of power-generating elements (20) includes a cathode (21), an anode (22) connected to the cathode (21) through the circuitry of the appliance and a container (23) with a protruding ring (231) extending from a top of the container (23).

The cathode (21) is made of aluminum-magnesium alloy, and the anode (22) is made of cupronickel. The manner in which the cathode (21) and the anode (22) are connected to the electrical appliance (10) is conventional so the description of the connection between the cathode (21) and the anode (22) and the electrical appliance (10) is omitted for simplicity. The container (23) contains fresh water (not numbered).

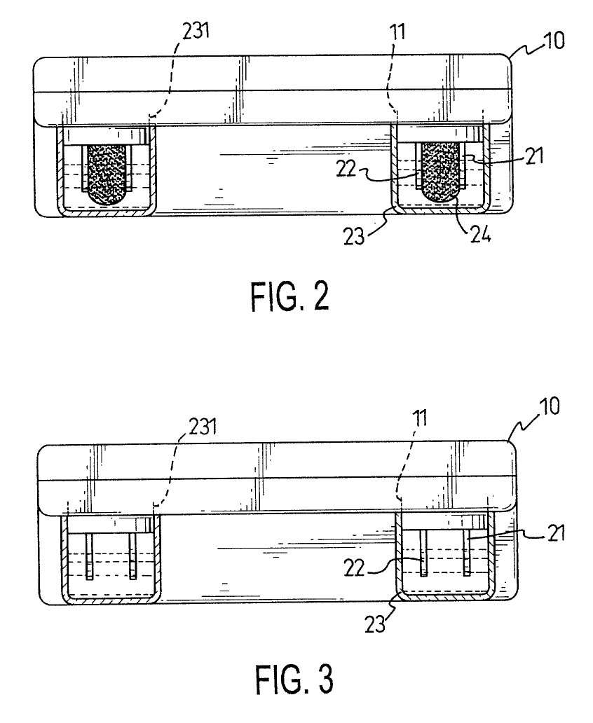

With reference to FIGS. 2, the power generating element (20) is assembled with the electrical appliance (10) by engaging the protruding ring (231) with a corresponding groove (11) defined in a bottom of the electrical appliance (10). Thereafter, when the cathode (21) and anode (22) are immersed in the fresh water, the chemical reaction between the cathode (21) and the anode (22) generates electricity for the electrical appliance (10). Furthermore, to maintain the chemical reaction between the cathode (21) and the anode (22) even when the electrical appliance (10) is away from the container (23), a sponge (24) is securely mounted between the cathode (21) and the anode (22). The sponge (24) also holds the electrolyte residue generated from the chemical reaction so that the fresh water is able to remain clean for a longer period of time when compared with the conventional power generating device.

The material for the cathode (21) may also be selected from a magnesium-lithium alloy or lithium. That is, when the cathode (21) is made of aluminum-magnesium alloy and the anode (22) is made of cupronickel, 1 volt is generated between the cathode (21) and the anode (22), which is higher than 0.7 volt of the conventional power generating device. Further, the amount of electrolyte residue generated by the aluminum-magnesium alloy cathode (21) and the cupronickel anode (22) is less than that of the conventional power generating device (97% less). Because manganese does not cause any verdigris so that the material for the anode (22) may also be manganese.

With reference to FIG. 3, when the sponge (24) (as shown in FIG. 2) is removed, the chemical reaction between the cathode (21) and the anode (22) still continues. This means that the sponge (24) only functions when the electrical appliance (10) is away from the container (23) and electricity is still required by the electrical appliance (10).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A power generating device for an electrical appliance which consumes little electricity, the power generating device comprising:
a cathode adapted to be securely connected to the electrical appliance;
an anode adapted to be securely connected to the electrical appliance so that the anode is able to be in series with the cathode through the circuitry of the appliance;
a container with water in the container so the cathode and anode are immersed in the water so that a chemical reaction between the cathode and anode generates electricity for the electrical appliance.

2. The power generating device as claimed in claim 1 further comprising a sponge removably mounted between the cathode and anode to hold water from the container in the sponge.

3. The power generating device as claimed in claim 1, wherein the cathode is made of a material selected from the group consisting of an aluminum-magnesium alloy, a magnesium-lithium alloy or lithium.

4. The power generating device as claimed in claim 3, wherein the anode is made of a material selected from the group consisting of cupronickel or manganese.
